(19) United States
(12) Patent Application Publication
(10) Pub. No.: US 2025/0284297 A1
(43) Pub. Date: Sep. 11, 2025

(54) MANAGEMENT SYSTEM FOR MOBILE OBJECT, PROGRAM, AND MANAGEMENT METHOD FOR MOBILE OBJECT

(71) Applicant: YAMABIKO CORPORATION, Tokyo (JP)

(72) Inventors: Ryota YAMADA, Ohme-shi (JP); Kenji NAKANO, Ohme-shi (JP); Benjamin HOUSSA, Ohme-shi (JP)

(21) Appl. No.: 18/039,861

(22) PCT Filed: Dec. 15, 2020
(86) PCT No.: PCT/JP2020/046658

§ 371 Date: Oct. 25, 2023

(51) Int. Cl. G05D 1/85; B60L 53/51; B60L 53/53; B60L 58/12

(52) U.S. Cl. CPC G05D 1/852; B60L 53/51; B60L 53/53; B60L 58/12

(57) ABSTRACT

A mobile object management system is provided. The management system comprises an information processing device including an acquisition unit, an instruction generation unit, and a transmission unit. The acquisition unit is configured to acquire remaining level information indicating the remaining level of a battery. The battery is configured to store power that a charging station supplies to a mobile object. The instruction generation unit generates, on the basis of the remaining level information, instruction information for controlling the mobile object. The instruction information is information related to operations by the mobile object. The transmission unit is configured to transmit the instruction information to the mobile object, whereby operations by the mobile object are controlled.

### CROSS REFERENCE TO RELATED APPLICATIONS

This application is a U.S. National Phase Application under 35 U.S.C. 371 of International Application No. PCT/JP2020/046658, filed on Dec. 15, 2020. The entire disclosure of the above application is expressly incorporated by reference herein.

### BACKGROUND

The present invention relates to a management system, a program, and a management method for a mobile object.

### RELATED ART

A mobile object such as a self-propelled robotic lawn mower can run even in an area where there is no electrical outlet (commercial power supply) using an external battery or other means.

CN 201426049 Y discloses a technology of using an external battery charged by solar power generation to operate a control device of a robot working machine so as to drive the robot working machine.

However, in the technology disclosed in CN 201426049 Y, operation of the robot working machine is not controlled according to remaining amount of the external battery charged by the solar power generation, thus after the remaining amount of the external battery becomes zero, position of the robot working machine cannot be recognized, making it difficult for the robot working machine to return to normal state.

### SUMMARY

According to an aspect of the present invention, a management system for a mobile object is provided. The management system comprises an information processing apparatus including an acquisition unit, an instruction generation unit, and a transmission unit. The acquisition unit is configured to acquire remaining amount information indicating remaining amount of a battery, wherein the battery is configured to store power supplying to the mobile object by a charging station. The instruction generation unit is configured to generate instruction information for controlling the mobile object based on the remaining amount information, wherein the instruction information is information regarding operation of the mobile object. The transmission unit is configured to transmit the instruction information to the mobile object, thereby operation of the mobile object is controlled.

According to such a management system for a mobile object, a mobile object such as a self-propelled robotic lawn mower can be stopped at a proper position before remaining amount of an external battery reaches zero, and can be returned to normal state after the external battery returns to charge.

### BRIEF DESCRIPTION OF THE DRAWINGS

FIG. 1 is a schematic diagram of a management system 1 for a mobile object 4 including an information processing apparatus 3.

FIG. 2 is a schematic diagram of a management system 1 including an information processing apparatus 3 and solar power generation 7 (renewable energy).

FIG. 3 is a schematic diagram of a management system 1 including an information processing apparatus 3 and an external server 8.

FIG. 4 is a block diagram showing a hardware configuration of an information processing apparatus 3.

FIG. 5 is a functional block diagram representing function performed by a controller 33 in an information processing apparatus 3.

FIG. 6 is a diagram showing an example of instruction information DI and operation information MI used in a management system 1.

FIG. 7 is a diagram showing an example of weather information WI and flight information OI used in a management system 1.

FIG. 8 is an activity diagram of a management method for a mobile object 4 according to an embodiment.

FIG. 9 is an activity diagram of a management method for a mobile object 4 according to an embodiment.

### DETAILED DESCRIPTION

Hereinafter, embodiment of the present invention will be described with reference to the drawings. Various features described in the embodiment below can be combined with each other.

A program for realizing a software may be provided as a non-transitory computer readable medium that can be read by a computer or may be provided for download from an external server or may be provided so that the program can be activated on an external computer to realize functions thereof on a client terminal (so-called cloud computing).

Further, in the present embodiment, “unit” or “means” may include, for instance, a combination of hardware resources implemented by a circuit in a broad sense and information processing of software that can be concretely realized thereby these hardware resources. Further, various information is performed in the present embodiment, and the information can be represented by, for instance, physical values of signal values representing voltage and current, high and low signal values as a set of binary bits consisting of 0 or 1, or quantum superposition (so-called qubits), and communication/calculation can be performed on a circuit in a broad sense.

Furthermore, the circuit in a broad sense is a circuit realized by combining at least an appropriate number of a circuit, a circuitry, a processor, a memory, or the like. In other words, it is a circuit includes application specific integrated circuit (ASIC), programmable logic device (e.g., simple programmable logic device (SPLD), complex programmable logic device (CPLD), field programmable gate array (FPGA)), or the like.

### 1. Overall Configuration

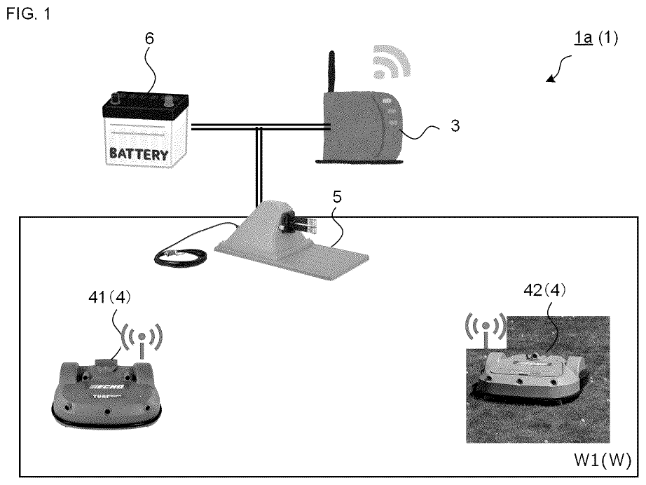

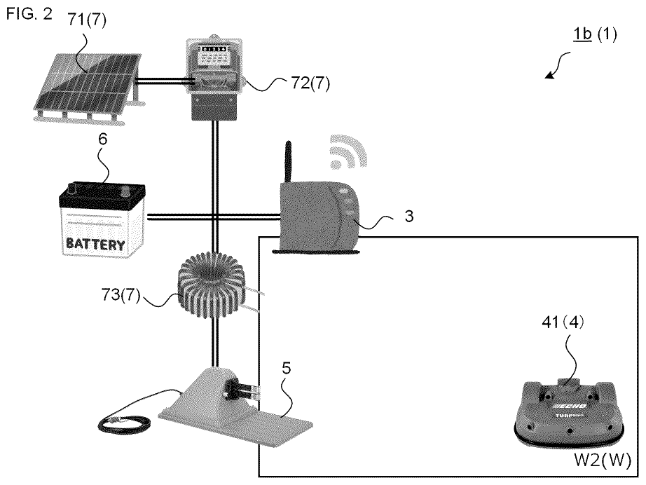

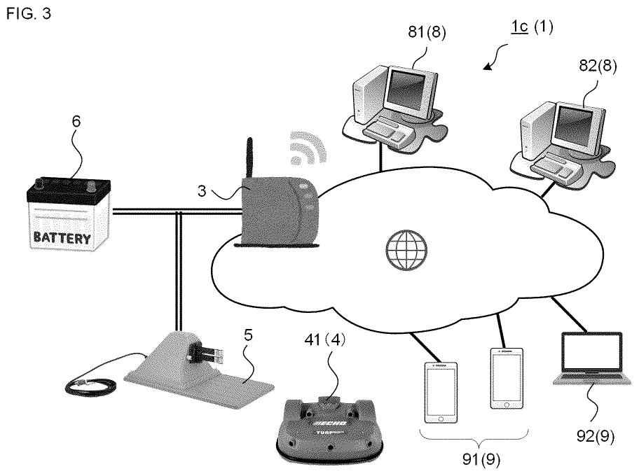

The present chapter describes a management system 1 for a mobile object 4 according to the present embodiment. FIG. 1 is a schematic diagram of a management system 1 for a mobile object 4 including an information processing apparatus 3. The management system 1 comprises the information processing apparatus 3, the mobile object 4, a charging station 5, and an external battery 6. The mobile object 4 freely travels within a working area W, and is charged by the external battery 6 in the working area W when remaining amount is declining. FIG. 2 is a schematic diagram of a management system 1 including an information processing apparatus 3 and solar power generation 7 (renewable energy). As represented in FIG. 2, the management system 1 further comprises the solar power generation 7. FIG. 3 is a schematic diagram of a management system 1 including an information processing apparatus 3 and an external server 8. As shown in FIG. 3, the management system 1 further comprises the external server 8, which are configured to communicate with each other through an electric communication line.

### 1.1. Information Processing Apparatus 3

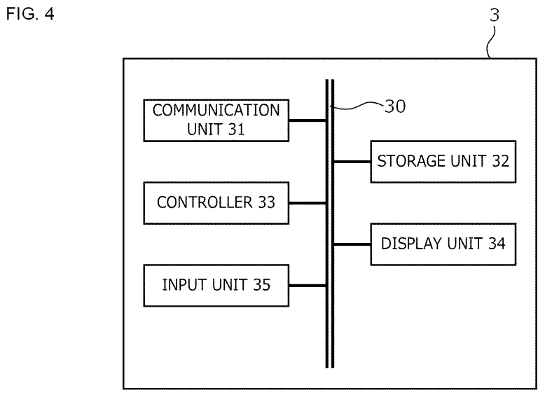

FIG. 4 is a block diagram showing a hardware configuration of the information processing apparatus 3. The information processing apparatus 3 comprises a communication unit 31, a storage unit 32, a controller 33, a display unit 34, and an input unit 35. These components may be electrically connected inside the information processing apparatus 3 via a communication bus 30.

### (Communication Unit 31)

Although wired type communication means such as USB, IEEE1394, Thunderbolt, wired LAN network communication, etc. are preferred, the communication unit 31 may include wireless LAN network communication, mobile communication such as LTE/5G, Bluetooth (registered trademark) communication, etc. if necessary. In other words, it is more preferable to implement as a set of these multiple communication means.

### (Storage Unit 32)

The storage unit 32 is configured to store various information as defined by the foregoing description. This can be implemented as a storage device such as a solid state drive (SSD) or as a memory such as a random access memory (RAM) that stores temporarily necessary information (arguments, arrays, etc.) related to program operation. Further, a combination thereof may be applied as well.

### (Controller 33)

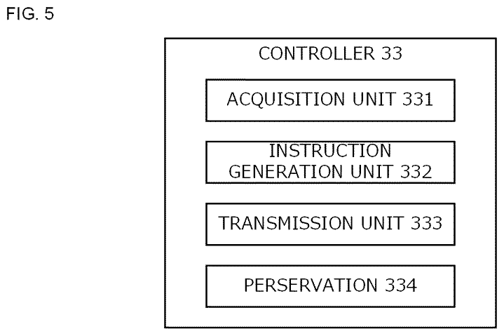

The controller 33 is configured to perform process and control of overall operation regarding the information processing apparatus 3. The controller 33 is, for instance, a central processing unit (CPU) (not shown). FIG. 5 is a functional block diagram representing function performed by the controller 33 in the information processing apparatus 3. The controller 33 is configured to implement various functions related to the information processing apparatus 3 by reading a predetermined program stored in the storage unit 32. In FIG. 5, the controller 33 is represented as a single one, but it is not limited thereto in practice, and may be implemented so as to include two or more controllers 33 for each function. Further, a combination thereof may be applied as well. Each of these functions will be described in detail in the next chapter.

### (Display Unit 34)

The display unit 34 may be included in the information processing apparatus 3 or may be externally attached, for instance. The display unit 34 is a display device such as a CRT display, a liquid crystal display, an organic EL display, a plasma display, or the like, which is externally attached to or built into the information processing apparatus 3. It is preferable to use different types of these devices according to type of the information processing apparatus 3. The display device responds to a control signal from the controller 33 and generates a display screen. The display screen can be selectively displayed in response to the control signal from the controller 33. A user can grasp operational status of the management system 1 or operational status of the mobile object 4 displayed on the display unit 34. These operating statuses may be displayed on an information processing terminal 9 of the user through an electric communication line.

### (Input Unit 35)

The input unit 35 is configured to receive various instructions or information input from the user. The input unit 35 is, for instance, a pointing device such as a mouse, a selection device such as a mode switch, or an input device such as a keyboard. The input unit 35 may use a graphical user interface (GUI) as well. The input unit 35 may be built into the information processing apparatus 3 or may be externally attached. Further, a user may send various instructions or information to the information processing apparatus 3 by uttering voice. Therefore, the input unit 35 may be a microphone. The user inputs setting value of the management system 1 or setting value regarding operation of the mobile object 4, such as traveling, working, etc., from the input unit 35. Further, the user may input various setting values from the information processing terminal 9 as well.

### 1.2. Mobile Object 4

The mobile object 4 may be a self-propelled vehicle or a manned vehicle. The mobile object 4 includes a power source capable of traveling. Therefore, the mobile object 4 may be a mobile object that travels on ground, travels at sea, or travels in air. The mobile object 4 may be electrically travelable with an internal battery (not shown) as a power source. The mobile object 4 may be a mobile working machine for performing a predetermined work. For instance, the mobile object 4 is a robotic lawn mower 41 or a ball picker robot 42. The robotic lawn mower 41 is a self-propelled robot that primarily mows lawn. The ball picker robot 42 is a self-propelled robot that collects balls. The ball is a sphere such as golf ball, tennis ball, baseball, etc. In particular, the mobile object 4 is preferably a ball picker robot 42 that collects golf ball since the management system 1 is used in a location where commercial power is difficult to obtain.

### 1.3. Charging Station 5

The charging station 5 is arranged in the working area W and supplies power to the mobile object 4. The charging station 5 comprises a connection terminal (not shown), which is connected to a connection terminal included in the mobile object 4 to supply power to the mobile object 4. The mobile object 4 stops at the charging station 5 until power is supplied to a battery included in the mobile object 4. The battery included in the mobile object 4 may be charged in this manner, or a charged battery and an empty battery may be exchanged at the charging station 5. Note that charging method at the charging station 5 is not limited.

### 1.4. External Battery 6

The external battery 6 is a battery that can be repeatedly charged and discharged (rechargeable battery). The external battery 6 refers to a secondary battery or a storage battery. These batteries are power devices that generate DC power through energy. The external battery 6 may be, but is not limited to, storage battery, alkaline storage battery, nickel cadmium battery, nickel metal hydride battery, lithium-ion battery, or the like, which are mainly used in a location where there is no commercial power supply. For instance, a large area such as park, golf course, airport, etc., where it is difficult to secure a commercial power source. In the present embodiment, the external battery 6 is configured to store power supplied to the mobile object 4 by the charging station 5.

### 1.5. Solar Power Generation 7

To use the external battery 6, electrical energy must be supplied from outside. Therefore, if solar power generation 7, wind power generation, biomass power generation, hydroelectric power generation, or geothermal power generation is available at a location where the mobile object 4 is used, the external battery 6 may be configured to store power from these renewable energies. Considering recent popularization and small power generation capability, the renewable energy it is preferably solar energy.

As represented in FIG. 2, the solar power generation 7 comprises a solar panel 71, a charge controller 72, and a converter 73. The solar panel 71 is made by collecting a plurality of solar batteries that convert small amounts of light energy into electrical energy, putting them into some kind of frame or structure and forming into a panel shape. The solar battery can be broadly classified into silicon-based, compound semiconductor-based, and organic-based, but are not limited thereto in the present embodiment. The charge controller 72 is connected between the solar panel 71 and the external battery 6 to prevent over charging, over discharging, or reverse current flow. The converter 73 includes a transformer function to change voltage of the external battery 6 and sends power to the charging station 5 with an appropriate voltage value.

### 1.6. External Server 8

The external server 8 is electrically connected to the information processing apparatus 3 through an electrical information line. Therefore, the information processing apparatus 3 is configured to access the external server 8, which is connected to the electrical information line, to obtain various information stored on the external server 8.

### 1.7. Information Processing Terminal 9

The information processing terminal 9 is a terminal such as tablet terminal, personal data assistant (PDA), notebook personal computer (PC), etc., or is a stand-alone type terminal that can be used alone. Thus, the information processing terminal 9 may be a portable terminal 91 such as a mobile terminal, or a PC 92 such as a fixed terminal. Such information processing terminal 9 is electrically connected to the information processing apparatus 3 through an electrical information line. Therefore, various information can be transmitted/received bidirectionally between the information processing terminal 9 and the information processing apparatus 3.

### 1.8. Working Area W

The working area W is an area that specifies a range for the mobile object 4 to travel. Shape of the working area W, in which the mobile object 4 can travel, is not limited as long as it is continuous and has a closed space. By recognizing the working area W, the mobile object 4 can travel within a designated working area W. A method for recognition is to bury a wire underground at an outer edge of the working area W, and pass electric current through the wire so as to allow the mobile object 4 to detect electric current and recognize the working area W.

### 1.9. Instruction Information DI and Operation Information MI

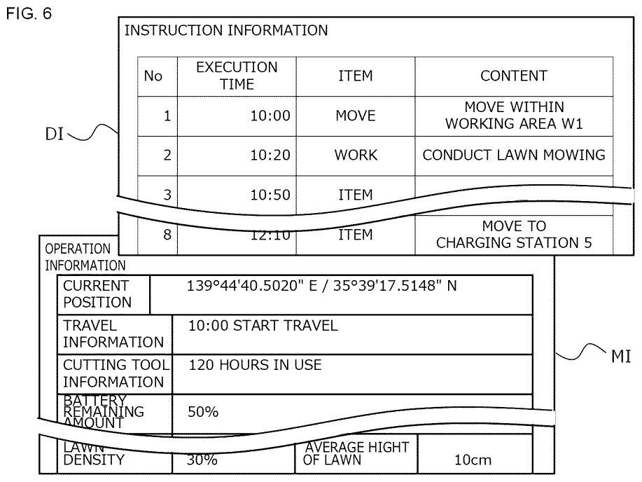

FIG. 6 is a diagram showing an example of instruction information DI and operation information MI used in the management system 1. The instruction information DI is a series of data that allows the information processing apparatus 3 to control the mobile object 4. The operation information MI is data related to travel history, travel status, or usage status of equipment such as internal batteries, devices, and parts provided by the mobile object 4, etc. The instruction information DI and the operation information MI shown in FIG. 6 are represented as examples, the data format and data content are not limited to these description examples.

### 1.10. Weather Information WI and Flight Information OI

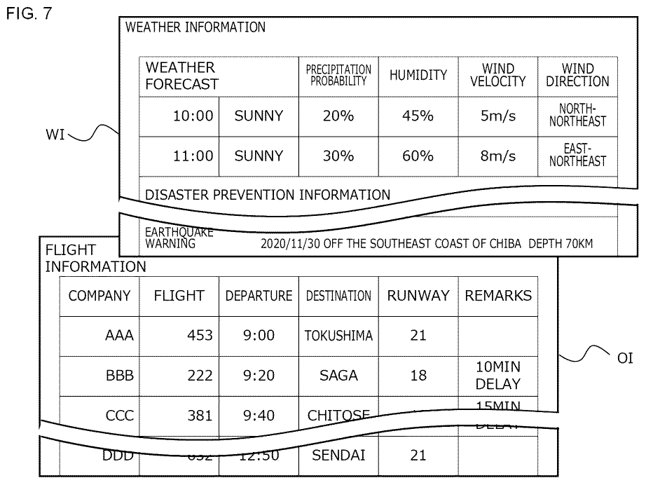

FIG. 7 is a diagram showing an example of weather information WI and flight information OI used in the management system 1. The weather information WI and the flight information OI are one of various types of information stored in the external server 8 and are external data that the information processing apparatus 3 refers to when controlling the mobile object 4. Data format and data content are not limited to these description examples.

### 2. Functional Configuration

Chapter 2 describes a functional configuration according to the present embodiment. As represented in FIG. 5, the information processing apparatus 3 configuring the management system 1 includes a controller 33, and furthermore, the controller 33 includes an acquisition unit 331, an instruction generation unit 332, a transmission unit 333, and a preservation unit 334. That is, information processing by software (stored in the storage unit 32) is specifically realized by hardware (controller 33), in such a manner that function of each unit can be performed. Hereinafter, each component will be further described.

### 2.1. Acquisition Unit 331

The acquisition unit 331 is configured to acquire information of various components (components of the management system 1) that can communicate with the information processing apparatus 3. Specifically, the acquisition unit 331 is configured to acquire remaining amount information indicating remaining amount of the external battery 6. The acquisition unit 331 is configured to acquire operation information MI regarding operation of the mobile object 4. Furthermore, the information processing apparatus 3 is configured to acquire information held by the external server 8 electrically connected to an electric communication line. Therefore, for instance, the acquisition unit 331 may be configured to acquire the weather information WI from an external server 81. Similarly, the acquisition unit 331 may be configured to acquire the flight information OI indicating aircraft operation status from an external server 82. Information useful for management of the mobile object 4 other than the above-mentioned information is all information to be acquired.

### 2.2. Instruction Generation Unit 332

The instruction generation unit 332 is configured to generate the instruction information DI that controls the mobile object 4. The instruction information DI is information regarding operation of the mobile object 4. Therefore, the instruction information DI may be data related to operation parameter or data related to operation program for controlling the mobile object 4. The instruction information DI is not limited as long as it controls operation of the mobile object 4 such as traveling, working, etc.

### 2.3. Transmission Unit 333

The transmission unit 333 transmits various information to various components (components of the management system 1) that can communicate with the information processing apparatus 3. As a result, the various components operate. Specifically, the transmission unit 333 is configured to transmit the instruction information DI to the mobile object 4, thereby controlling operation of the mobile object 4. Furthermore, the information processing apparatus 3 is configured to transmit various information to the external server 8, which is electrically connected to an electric communication line. Therefore, the transmission unit 333 is configured to transmit the operation information MI possessed by the mobile object 4 among the various information to the external server 8 that controls the mobile object 4. The timing at which the transmission unit 333 transmits the various information is not limited. The transmission unit 333 may transmit the various information when a certain event occurs or in response to a request from the user or the mobile object 4, or the transmission unit 333 may transmit the various information at a predetermined time.

### 2.4. Preservation Unit 334

The preservation unit 334 is configured to store the instruction information DI for the information processing apparatus 3 to control the mobile object 4, or the operation information MI acquired by the information processing apparatus 3 from the mobile object 4. In addition to these pieces of information, the preservation unit 334 may store various information such as the weather information WI and the flight information OI acquired by the information processing apparatus 3 from the external server 8 in the storage unit 32.

### 3. Function of Management System 1

Each function of the management system 1 described in Chapters 1 and 2 will be illustrated in Chapter 3.

### 3.1. Function for Controlling Mobile Object 4 According to Remaining Amount of External Battery 6

When the mobile object 4 is a robotic lawn mower 41 or a ball picker robot 42, as represented in FIG. 1, primary service space of the mobile object 4 is golf course, airfield, or park. Hereinafter, the mobile object 4 is described as the robotic lawn mower 41. Many of outdoor locations described above are not comprise commercial power supply, and the user needs to use the external battery 6 to run the robotic lawn mower 41 (mobile object 4). That is, the external battery 6 supplies power to the charging station 5 that supplies power to an internal battery (not shown) comprised in the mobile object 4, the information processing apparatus 3 that controls the mobile object 4, and a wire laid on an outer edge of the working area W as described above.

In such a location, if charge level of the external battery 6 drops and power is not properly supplied to each device, the mobile object 4 may unable to recognize location of the charging station 5 or the wire laid on the outer edge of the working area W. Once the robotic lawn mower 41 (mobile object 4) is in such a state, it stops for safety reason. Further, even if the information processing apparatus 3 stops and becomes unable to communicate with the robotic lawn mower 41 (mobile object 4), the robotic lawn mower 41 will eventually stop. The robotic lawn mower 41 (mobile object 4) in such a stopped state needs to be operated directly by the user to restore. Therefore, the user needs to move within the wide working area W. In some cases, the user needs to supply power directly to the internal battery of the mobile object 4.

To solve the above-mentioned problem, the acquisition unit 331 of the information processing apparatus 3 electrically connected to the external battery 6 is configured to acquire remaining amount information indicating remaining amount of the external battery 6. Timing at which the acquisition unit 331 acquires the remaining amount information may be, for instance, at a predetermined interval or when the remaining amount information falls below a predetermined threshold by a sensor (not shown) provided in the external battery 6. At any timing, the instruction generation unit 332 may generate instruction information DI for controlling the robotic lawn mower 41 (mobile object 4) based on the remaining amount information acquired by the acquisition unit 331. The generated instruction information DI is transmitted to the mobile object 4 by the transmission unit 333.

Here, the instruction information DI for controlling the robotic lawn mower 41 (mobile object 4) may be information for the robotic lawn mower 41 (mobile object 4) to move to a wire laid on the outer edge of the working area W, or may be information for moving to a predetermined location. Moving location is not limited as long as the mobile object 4 can move safely. However, to quickly charge the internal battery of the mobile object 4 after the external battery 6 has been charged, it is preferred that the robotic lawn mower 41 (mobile object 4) be configured to move to the charging station 5 based on the instruction information DI. Content of the instruction information DI may be determined according to the remaining amount of the external battery 6. The instruction information DI may be information regarding work specific to the robotic lawn mower 41 (mobile object 4). For instance, if the mobile object 4 is the robotic lawn mower 41, the instruction information DI may be to stop the robotic lawn mower 41 from mowing lawn.

By controlling the robotic lawn mower 41 (mobile object 4) according to the remaining amount of the external battery 6 in this way, the robotic lawn mower 41 (mobile object 4) can return to the charging station 5 in advance even if a wire surrounding the working area W stops functioning due to the low remaining amount of the external battery 6. This reduces the need for the user to travel to a side of the robotic lawn mower 41 (mobile object 4), which is stopped within the wide working area W, to perform a return operation. Work efficiency of the robotic lawn mower 41 (mobile object 4) may improve by reducing such return operation.

### 3.2. Function for Controlling Mobile Object 4 by Understanding State of the Mobile Object 4

The information processing apparatus 3 may control the mobile object 4 based on various information possessed by various electrically connected and communicable components (components of the management system 1) as well as the external battery 6. Specifically, the acquisition unit 331 is configured to acquire operation information MI regarding operation of the mobile object 4, and the instruction generation unit 332 is configured to generate instruction information DI for controlling the mobile object 4 based on the operation information MI. For instance, the instruction generation unit 332 may generate the instruction information DI according to the remaining amount of the internal battery of the mobile object 4. Before the internal battery of the mobile object 4 becomes too low to travel, the instruction generation unit 332 generates instruction information DI to return to the charging station 5, and the transmission unit 333 transmits the instruction information DI to the mobile object 4.

Here, the operation information MI is not only the remaining amount of the internal battery of the mobile object 4, but also various information related to operation of the mobile object 4. For instance, the various information may be operation information such as travel distance of the mobile object 4, information on area where work has been completed, or the like. If the mobile object 4 is the robotic lawn mower 41, the operation information MI may include state (density) of lawn or state of a cutting tool of the robotic lawn mower.

The instruction information DI is generated according to content of the operation information MI. When the operation information MI is the state (density) of the lawn, the instruction information DI regarding operation of the robotic lawn mower 41 (mobile object 4), such as operation parameter of the cutting tool or a working range of the robotic lawn mower 41 (mobile object 4), is generated. Further, when the operation information MI is the state of the cutting tools of the robotic lawn mower 41 (mobile object 4), if the cutting tool is a poor condition, the instruction information DI to return to the charging station 5 is generated and the robotic lawn mower 41 (mobile object 4) waits at the charging station 5 until the cutting tool is replaced with new one.

By generating the instruction information DI based on the operation information MI possessed by the mobile object 4, the mobile object 4 is controlled based on latest state of the mobile object 4. As a result, the information processing apparatus 3 can accurately control the mobile object 4. When the mobile object 4 is the robotic lawn mower 41 or the ball picker robot 42, if an abnormality is detected in a part possessed by the mobile object 4, it can quickly return to the charging station 5, ensuring safe travel and work. The instruction information DI is an example and is generated according to usage location and usage condition of the robotic lawn mower 41.

3.3. Function to Control Mobile Object 4 Based on Information from External Server 8

The instruction information DI may be generated by the instruction generation unit 332 of the information processing apparatus 3 according to a predetermined rule, or may be generated based on information transmitted from the external server 8. The transmission unit 333 transmits the operation information MI to the external server 8. The user may confirm content of the operation information MI transmitted to the external server 8 and, if necessary, send the instruction information DI to the information processing apparatus 3. The transmission unit 333 further transmits the instruction information DI transmitted from the external server 8 to the mobile object 4. In this way, by cooperating with the external server 8, the management system 1 can solve problem that is difficult to solve by exchanging information between the information processing apparatus 3 and the mobile object 4 through intervention of the user.

The information processing apparatus 3 is configured to communicate with not only the external server 8 owned by the user but also other various external servers 8 through an electric communication line. Therefore, the acquisition unit 331 is configured to acquire weather information WI from the external server 81. The instruction generation unit 332 is configured to generate instruction information DI for controlling the mobile object 4 based on the weather information WI. Further, the acquisition unit 331 is configured to acquire flight information OI indicating aircraft operation status from the external server 82. The instruction generation unit 332 is configured to generate instruction information DI for controlling the mobile unit based on the flight information OI. The weather information WI and the flight information OI are only examples, and the acquisition unit 331 is configured to acquire all information possessed by the external server 8 that is useful for controlling the mobile object 4. The instruction generation unit 332 is configured to generate instruction information DI based on the useful information.

The weather information WI includes not only weather information for an area in which the mobile object 4 travels, but also disaster prevention information such as earthquake information, tsunami information, volcano information, and typhoon information. Based on the weather information WI, the instruction generation unit 332 generates instruction information DI including, for example, a time period during which the mobile object 4 is allowed to travel and work. By having the acquisition unit 331 acquire the weather information WI in advance, the management system 1 can safely control the mobile object 4 to protect device of the mobile object 4 and allow it to operate without malfunction. Further, it also leads to ensuring safety of the location where the mobile object 4 is used.

If the mobile object 4 is the robotic lawn mower 41, the robotic lawn mower 41 may be used in an airport. In such a case, movement of the mobile object 4 that uses radio wave to move is restricted for safety reason under law such as the Civil Aeronautics Act. Therefore, based on the flight information OI, the instruction generation unit 332 generates instruction information DI including, for example, the time period during which the mobile object 4 is allowed to travel and work. By having the acquisition unit 331 acquire the flight information OI in advance, the management system 1 can ensure safety of the airport or other location where the mobile object 4 is used by safely controlling the mobile object 4.

3.4. Function for Controlling Mobile Object 4 Based on Information that Communication Between Information Processing Apparatus 3 and Mobile Object 4 is Unavailable

The mobile object 4 is configured to continue operation, such as traveling, based on latest instruction information DI acquired from the information processing apparatus 3 prior to this when communication with the information processing apparatus 3 is unavailable. Therefore, the management system 1 can operate the mobile object 4 normally even if communication failure occurs between the information processing apparatus 3 and the mobile object 4 due to unforeseen circumstances. The latest instruction information DI here does not specify only the most recent instruction information DI, but includes a series of instruction information DI that allows normal operation.

For instance, when it is determined that the mobile object 4 is unable to communicate with the information processing apparatus 3, if the instruction information DI to return to the charging station 5 in 10 minutes has already been transmitted to the mobile object 4, the mobile object 4 promptly returns to the charging station 5 in 10 minutes. Further, when the mobile object 4 has last received the instruction information DI to work in another working area W, the mobile object 4 promptly returns to the charging station 5 after working in another working area W.

In this manner, by continuing operation such as traveling based on the latest instruction information DI and having the information processing apparatus 3 move the mobile object 4 to a predetermined location such as a charging station 5, the latest instruction information DI is surely fulfilled and the mobile object 4 can be allowed to move to a safe location. Even if communication between the information processing apparatus 3 and the mobile object 4 becomes unavailable, a user who manages the mobile object 4 is relieved of the burden of restoration operation since the mobile object 4 can operate based on the instruction information DI until then.

With the functions described above, the management system 1 can safely and efficiently operate the mobile object 4 such as the robotic lawn mower 41 or the ball picker robot 42 even in a location where commercial power supply is unavailable. In addition, since the external battery 6 can be charged by renewable energy source such as solar power generation 7, the management system 1 for mobile object such as the robotic lawn mower 41 or the ball picker robot 42 will be beneficial for a sustainable society in the future.

### 4. Management Method Using Management System 1

Chapter 4 describes a management method using the management system 1 described in Chapters 1 through 3. Hereinafter, a method of managing the mobile object 4 according to remaining amount of the external battery 6 and a method of managing the mobile object 4 by understanding state of the mobile object 4 will be described separately.

### 4.1. Method of Managing Mobile Object 4 According to Remaining Amount of External Battery 6

A management method described here is a method of managing the mobile object 4 according to remaining amount of the external battery 6. The management method includes an acquisition step, an instruction generation step, and a transmission step. In the acquiring step, remaining amount information indicating remaining amount is acquired. A battery is configured to store power that is supplied to the mobile object 4 by the charging station 5. In the instruction generation step, instruction information DI for controlling the mobile object 4 is generated based on the remaining amount information. The instruction information DI is information regarding operation of the mobile object 4. In the transmitting step, the instruction information DI is transmitted to the mobile object 4, thereby the operation of the mobile object 4 is controlled. Specifically, the method of controlling the mobile object 4 will be described below.

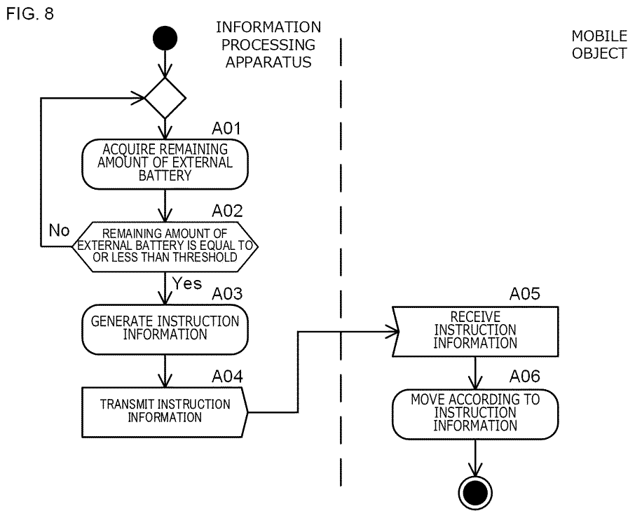

FIG. 8 is an activity diagram of the management method for the mobile object 4 according to the present embodiment. Description will be made below along with the drawing.

### (Activity A01)

The acquisition unit 331 acquires the remaining amount of the external battery 6.

### (Activity A02)

This activity is to confirm whether the acquired remaining amount of the battery is equal to or less than a threshold. If it is equal to or less than the threshold, Activity A03 is executed. If it is not equal to or less than the threshold, Activity A01 is executed.

### (Activity A03)

The instruction generation unit 332 generates the instruction information DI.

### (Activity A04)

The transmission unit 333 transmits the instruction information DI to the mobile object 4.

### (Activity A05)

The mobile object 4 receives the operation information MI.

### (Activity A06)

The mobile object 4 moves according to work instruction information. The robotic lawn mower 41 (mobile object 4) returns to the charging station 5.

### 4.2. Method of Managing Mobile Object 4 by Understanding State of the Mobile Object 4

A management method described here is a method of managing the mobile object 4 by understanding state of the mobile object 4. The management method has an acquisition step, an instruction generation step, and a transmission step. In the acquiring step, operation information MI regarding operation of the mobile object 4 is acquired, in the instruction generating step, instruction information for controlling the mobile object 4 is generated based on the operation information MI, and in the transmitting step, the instruction information is transmitted to the mobile object 4, thereby the operation of the mobile object 4 is controlled. Specifically, the method of controlling the mobile object 4 will be described below.

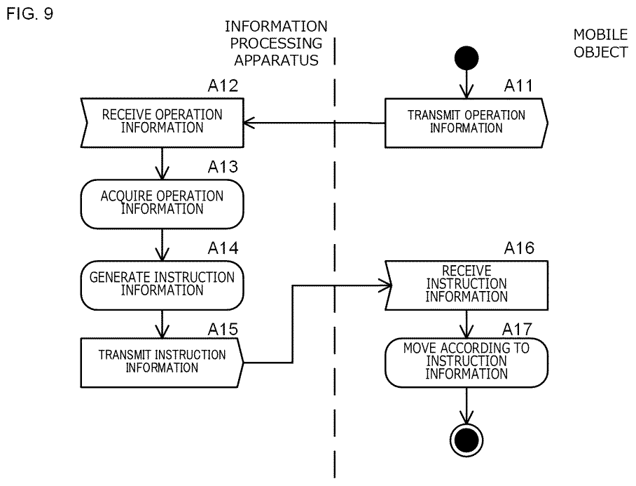

FIG. 9 is an activity diagram of the management method for the mobile object 4 according to the present embodiment. Description will be made below along with the drawing.

### (Activity A11)

The mobile object 4 transmits the operation information MI to the information processing apparatus 3.

### (Activity A12)

The information processing apparatus 3 receives the operation information MI.

### (Activity A13)

The acquisition unit 331 acquires the operation information MI transmitted from the mobile object 4.

### (Activity A14)

The instruction generation unit 332 generates instruction information based on the acquired operation information MI.

### (Activity A15)

The transmission unit 333 transmits the instruction information to the mobile object 4.

### (Activity A16)

The mobile object 4 receives the instruction information.

### (Activity A17)

The mobile object 4 moves according to the instruction information. Alternatively, the mobile object 4 works according to the instruction information.

### 5. Others

The above-described embodiment may be implemented according to the following manner.

(1) The information processing apparatus 3 may comprise a prediction unit. The prediction unit is configured to calculate hourly consumption rate of the internal battery of the mobile object 4 from the operation information MI of the mobile object 4 and predicts time for the mobile object 4 to return to the charging station 5. By receiving the predicted return time, the mobile object 4 can use up enough power of its internal battery to return to the charging station 5, even if communication failure with the information processing apparatus 3 occurs.

(2) The information processing apparatus 3 may comprise a work planning unit. When the mobile object 4 is the robotic lawn mower 41 or the ball picker robot 42, the work planning unit is configured to plan a work plan in such a manner that the mobile object 4 is working within a specified distance from the charging station 5 when remaining amount of the external battery 6 drops to a threshold. The robotic lawn mower 41 or the ball picker robot 42 can operate based on the work plan to improve work efficiency.

(3) The information processing apparatus 3 may comprise a prediction unit, and the acquisition unit 331 may acquire aerial photographs of the working area W on which the mobile object 4 is traveling from the external server 8. When the mobile object 4 is the robotic lawn mower 41 or the ball picker robot 42, the prediction unit is configured to predict obstacle and area with a large work load from the acquired aerial photograph, and the work planning unit plans a work plan for the robotic lawn mower 41 or the ball picker robot 42 based on the information. The robotic lawn mower 41 or the ball picker robot 42 can operate based on the work plan to obtain safety and high work efficiency.

(4) A program configured to allow a computer to function as each unit of the management system 1 may be provided as well.

Furthermore, the present invention may be provided in each of the following aspects.

The management system, wherein: the acquisition unit is configured to acquire operation information regarding operation of the mobile object, and the instruction generation unit is configured to generate the instruction information for controlling the mobile object based on the operation information.

The management system, wherein: the transmission unit is configured to transmit the operation information to an external server managing the mobile object.

The management system, wherein: the mobile object is configured to move to the charging station based on the instruction information.

The management system, wherein: the battery is configured to store power from renewable energy.

The management system, wherein: the renewable energy is solar energy.

The management system, wherein: the acquisition unit is configured to acquire weather information from an external server, and the instruction generation unit is configured to generate the instruction information for controlling the mobile object based on the weather information.

The management system, wherein: the acquisition unit is configured to acquire flight information indicating aircraft operation status from an external server, and the instruction generation unit is configured to generate the instruction information for controlling the mobile object based on the flight information.

The management system, wherein: when communication with the information processing apparatus is unavailable, the mobile object is configured to continue traveling based on latest instruction information previously acquired from the information processing apparatus.

The management system, wherein: the mobile object is a robotic lawn mower or a ball picker robot.

The management system, wherein: the acquisition unit is configured to acquire operation information regarding movement of the mobile object, and the operation information includes state of lawn or state of cutting tool of robotic lawn mower.

A program, wherein: the program is configured to allow a computer to function as each unit of the management system.

A management method for a mobile object, comprising: an acquiring step of acquiring remaining amount information indicating remaining amount of a battery, wherein the battery is configured to store power supplying to the mobile object by a charging station; an instruction generating step of generating instruction information for controlling the mobile object based on the remaining amount information, wherein the instruction information is information regarding operation of the mobile object; and a transmitting step of transmitting the instruction information to the mobile object, thereby operation of the mobile object is controlled.

Of course, the present invention is not limited to the above aspects.

Finally, various embodiments of the present invention have been described, but these are presented as examples and are not intended to limit the scope of the invention. The novel embodiment can be implemented in various other forms, and various omissions, replacements, and changes can be made without departing from the abstract of the invention. The embodiment and its modifications are included in the scope and abstract of the invention and are included in the scope of the invention described in the claims and the equivalent scope thereof.

What is claimed is:

1. A management system for a mobile object, comprising:
an information processing apparatus including a processor configured to execute a program stored in a memory so as to:
acquire remaining amount information indicating remaining amount of a battery, wherein the battery is configured to store power supplying to the mobile object by a charging station;
generate instruction information for controlling the mobile object based on the remaining amount information, wherein the instruction information is information regarding operation of the mobile object; and
transmit the instruction information to the mobile object, thereby operation of the mobile object is controlled.

2. The management system according to claim 1, wherein:
the processor is configured to execute the program so as to acquire operation information regarding operation of the mobile object, and
generate the instruction information for controlling the mobile object based on the operation information.

3. The management system according to claim 2, wherein:
the processor is configured to execute the program so as to transmit the operation information to an external server managing the mobile object.

4. The management system according to claim 1, wherein:
the mobile object is configured to move to the charging station based on the instruction information.

5. The management system according to claim 1, wherein:
the battery is configured to store power from renewable energy.

6. The management system according to claim 5, wherein:
the renewable energy is solar energy.

7. The management system according to claim 1, wherein:
the processor is configured to execute the program so as to acquire weather information from an external server, and
generate the instruction information for controlling the mobile object based on the weather information.

8. The management system according to claim 1, wherein:
the processor is configured to execute the program so as to acquire flight information indicating aircraft operation status from an external server, and
generate the instruction information for controlling the mobile object based on the flight information.

9. The management system according to claim 1, wherein:
when communication with the information processing apparatus is unavailable, the mobile object is configured to continue traveling based on latest instruction information previously acquired from the information processing apparatus.

10. The management system according to claim 1, wherein:
the mobile object is a robotic lawn mower or a ball picker robot.

11. The management system according to claim 10, wherein:
the processor is configured to execute the program so as to acquire operation information regarding movement of the mobile object, and
the operation information includes state of lawn or state of cutting tool of robotic lawn mower.

12. A non-transitory computer readable media storing the program of claim 1, wherein:
the program causes a computer to perform the acquire, the generate and the transmit elements of the management system.

13. A management method for a mobile object, comprising:
an acquiring step of acquiring remaining amount information indicating remaining amount of a battery, wherein the battery is configured to store power supplying to the mobile object by a charging station;
an instruction generating step of generating instruction information for controlling the mobile object based on the remaining amount information, wherein the instruction information is information regarding operation of the mobile object; and
a transmitting step of transmitting the instruction information to the mobile object, thereby operation of the mobile object is controlled.
